(19) United States
(12) Patent Application Publication
(10) Pub. No.: US 2008/0012390 A1
(43) Pub. Date: Jan. 17, 2008

(54) STRUCTURAL PART FOR THE BODY OR UNDERCARRIAGE OF A MOTOR VEHICLE

(75) Inventor: Wolfgang Streubel, Detmold (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/779,625

(22) Filed: Jul. 18, 2007

Related U.S. Application Data
(62) Division of application No. 11/241,848, filed on Sep. 30, 2005, now abandoned.

(30) Foreign Application Priority Data
Oct. 13, 2004 (DE) 10 2004 049 949.7

(51) Int. Cl. B60R 27/00; B21D 53/88

(52) U.S. Cl. 296/203.01; 29/897.2

(57) ABSTRACT

A structural part for a body or undercarriage of a motor vehicle includes a channel-shaped or hollow length portion made of steel sheet; and a bulkhead received for reinforcement in the length portion in an area of high stress. The bulkhead hereby extends in parallel relationship to the longitudinal axis of the length portion.

### CROSS-REFERENCES TO RELATED APPLICATIONS

This application is a divisional of prior filed copending U.S. application Ser. No. 11/241,848, filed Sep. 30, 2005, the priority of which is hereby claimed under 35 U.S.C. §120, and which claims the priority of German Patent Application, Serial No. 10 2004 049 949.7, filed Oct. 13, 2004, pursuant to 35 U.S.C. 119(a)-(d), the contents of which are incorporated herein by reference.

### BACKGROUND OF THE INVENTION

The present invention relates to a structural part for the body or undercarriage of a motor vehicle.

Nothing in the following discussion of the state of the art is to be construed as an admission of prior art.

German Offenlegungsschrift DE 197 28 582 A1 discloses a method of making a metal piece by bending, pressing and/or deep drawing a flat sheet metal blank in several successive steps to form an intermediate metal product which has a plurality of substantially parallel bending lines and a channel-shaped profile or partial profile with a cross section perpendicular to the bending lines. To enhance the buckling strength or twist stiffness so as to decrease warping during subsequent shaping operations, the channel-shaped profile or partial profile is reinforced by at least one stiffening sheet which is received in the profile or partial profile in substantial perpendicular relationship to the bending lines and securely fixed to the metal sheet, before the intermediate metal product is shaped into the final metal piece. The addition of stiffening sheets causes an increase in the overall vehicle weight. Moreover, the stiffening sheets interfere and require the provision of openings to permit, for example, installation of cables, tubes and the like in the reinforced metal pieces. In particular the increase in weight runs counter to the manufacturer's desire for a weight reduction.

It would therefore be desirable and advantageous to provide an improved structural part for a body or undercarriage of a motor vehicle such as a passenger car, to obviate prior art shortcomings and to exhibit stiffness for any application while yet having little weight.

### SUMMARY OF THE INVENTION

According to one aspect of the present invention, a structural part for a body or undercarriage of a motor vehicle includes a length portion made of steel sheet and defined by a longitudinal axis, and a bulkhead received for reinforcement in the length portion in an area of high stress and extending in parallel relationship to the longitudinal axis. The length portion may hereby be a channel-shaped or hollow.

The present invention resolves prior art problems by employing bionic thinking and integrating at least one transverse bulkhead and/or longitudinal bulkhead in the channel-shaped or hollow length portion to thereby create a structural part which can be tailored to have a reinforcement only in those zones that are exposed to greater stress during use, whereas the other zones of the length portion may be constructed of thinner wall thickness. As a result, weight is reduced and material can be saved.

The number of bulkheads and their disposition as well as their configuration depends on the type of stress the structural part is subjected to. For example, it is possible to arrange two or more transverse bulkheads immediately next to one another, or to place a longitudinal bulkhead continuously from end to end or in individual sections. Although a bulkhead can be incorporated in the length portion in many ways, e.g., by gluing or soldering, currently preferred is the use of a welding operation, whereby spot welding or linear welding may be involved.

According to another feature of the present invention, the length portion may be made by shaping a plate of steel sheet. The plate may hereby be shaped into a channel-shaped length portion of hollow length portion of various cross sectional configuration.

According to another feature of the present invention, adjacent edges of the plates can be connected by welding to one another at least sectionwise. For example, in the event of two shells of U-shaped cross section, the free edges of the legs can be placed next to one another to thereby realize a box-shaped or tubular length portion. Before connecting both shells, at least one bulkhead is placed in a shell and secured in place. It may also be conceivable to shape a single-piece plate into a tubular length portion having a round, oval, rectangular or triangular cross section. The longitude edges can be welded to one another after the bulkhead has been deposited.

According to another feature of the present invention, the bulkhead may be provided with a transverse or longitude crease, or protrusion in the form of an embossment, and/or opening.

According to another feature of the present invention, the length portion may be made by stamping or compressing a tube in a radial direction, realizing a length portion whose wall is comprised of two layers. The bulkhead can then be secured in place at the intended site in the length portion.

According to another aspect of the present invention, a method of making a structural part for a body or undercarriage of a motor vehicle includes the steps of shaping a plate of steel sheet to form a shell of U-shaped cross section, securing a bulkhead in the shell, bending marginal areas next to free edges of the shell about the bulkhead to form the a length portion, and welding the edges, at least sectionwise. As a result, the structural part is reinforced in areas that are practical for use, similar to the of a natural bamboo pole.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGS. 1 to 6 are perspective illustrations of various embodiments of a length portion of a structural part according to the present invention;

FIG. 7a-7e are schematic perspective illustrations of a sequence of process steps for making the length portion of FIG. 1;

FIGS. 8-10 are perspective illustrations of further embodiments of a length portion of a structural part according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a perspective view of one embodiment of a length portion according to the present invention, generally designated by reference numeral 1 and forming part of an otherwise unillustrated structural part for a body or undercarriage of a motor vehicle. The length portion 1 has a circular cross section and accommodates a transverse bulkhead 2 to provide a partition or separating wall in the form of a round steel sheet which is welded in place. The length portion 1 is hereby made by appropriately bending a plate of steel sheet, with the adjacent free edges 3 of the length portion 1 being connected by a weld seam 4.

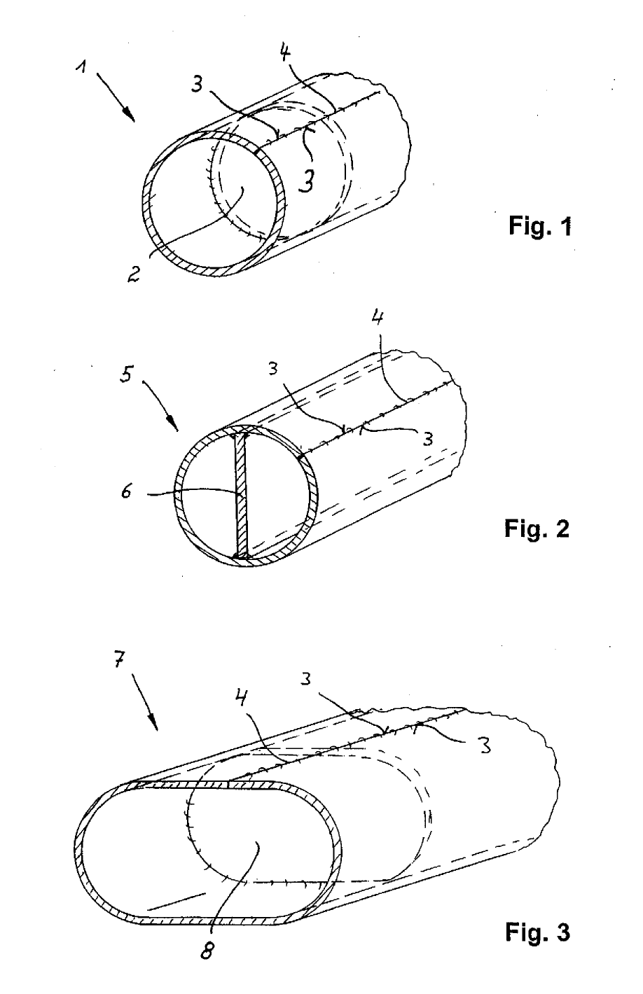

FIG. 2 shows another embodiment of a length portion according to the present invention, generally designated by reference numeral 5. Parts corresponding with those in FIG. 1 are denoted by identical reference numerals and not explained again. The description below will center on the differences between the embodiments. In this embodiment, the length portion 5 has also a tubular configuration and is longitudinally welded. Provision is made however for a longitudinal bulkhead 6, instead of a transverse bulkhead, for reinforcement of the length portion 5. The longitudinal bulkhead 6 may extend continuously from end to end or may, optionally, be divided in partial sections also of different length.

FIG. 3 shows yet another embodiment of a length portion according to the present invention, generally designated by reference numeral 7 and also longitudinally welded. Parts corresponding with those in FIG. 1 are denoted by identical reference numerals and not explained again. The description below will center on the differences between the embodiments. In this embodiment, the length portion 7 has an oval cross section and accommodates a complementarily configured transverse bulkhead 8 which is welded in place. As an alternative to the transverse bulkhead 8, the length portion 7 may also accommodate at least one longitudinal bulkhead similar to the one shown in FIG. 2.

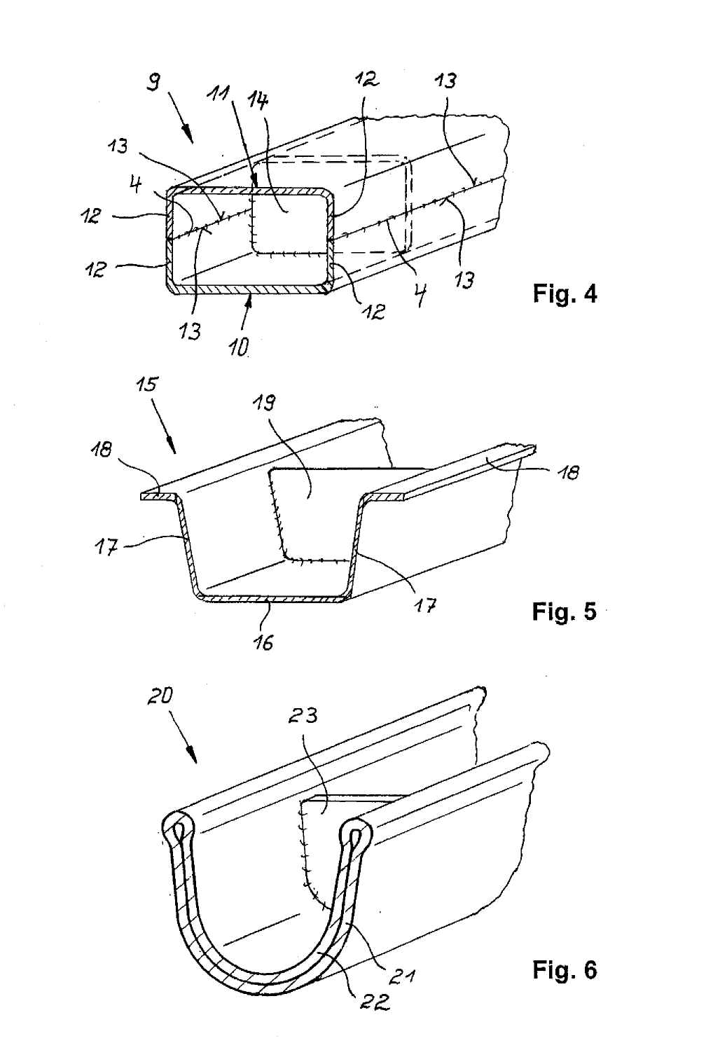

FIG. 4 shows still another embodiment of a length portion according to the present invention, generally designated by reference numeral 9. The length portion 9 has a hollow, box-shaped configuration comprised of two shells 10, 11 of U-shaped cross section. The confronting legs 12 of the shells 10, 11 are welded to one another along their longitude edges. Welded into the length portion 9 is a transverse bulkhead 14 of a configuration complementing he configuration of the length portion 9. As an alternative to the transverse bulkhead 14, the length portion 9 may also accommodate at least one longitudinal bulkhead similar to the one shown in FIG. 2.

FIG. 5 shows still another embodiment of a length portion according to the present invention, generally designated by reference numeral 15. The length portion 15 has a channel-shaped configuration with a trapezoidal cross section and includes a bottom 16, two inclined legs 17, and flanges 19 adjoining the ends of the legs 17. Welded between the legs 17 and the bottom 16 is a transverse bulkhead 19.

FIG. 6 shows yet another embodiment of a length portion according to the present invention, generally designated by reference numeral 20. The length portion 20 has also a channel-shaped configuration and is realized by radially stamping or compressing a tube. As a result, the length portion 20 has two coextensive adjacent walls 21, 22. A transverse bulkhead 23 Is welded in to the length portion 20.

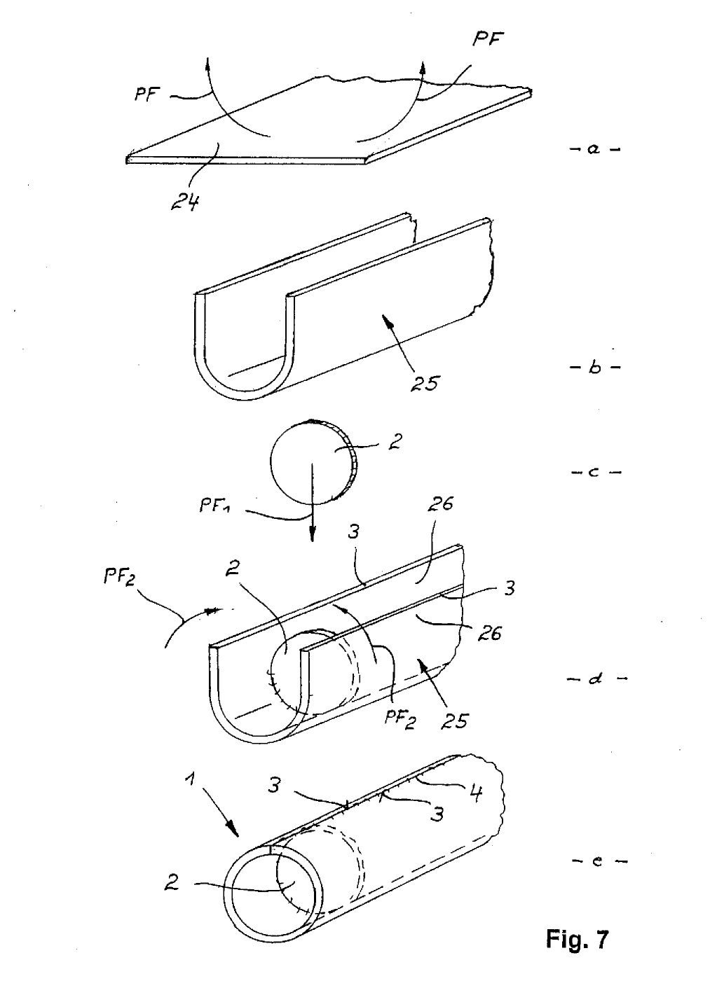

Referring now to FIGS. 7a-7e, there are shown schematic perspective illustrations of a sequence of process steps for making the length portion of FIG. 1. As shown in FIG. 7a, a plate 24 of steel sheet is bent in a direction indicated by arrows PF to form a U-shaped shell 25, as shown in FIG. 7b. Inserted in the shell 25 in a direction indicated by arrow PF₁ is a round sheet 2 (FIG. 7c) and fixed in place through a welding process (spot welding or linear welding) to realize a transverse bulkhead 2. This is shown in FIG. 7d. Afterwards, the marginal zones 26 of the shell 25 next to the free edges 3 are bent around the transverse bulkhead 2 until the free edges 3 confront one another. Then, the free edges 3 are welded together, as shown in FIG. 7e to finish the length portion 1.

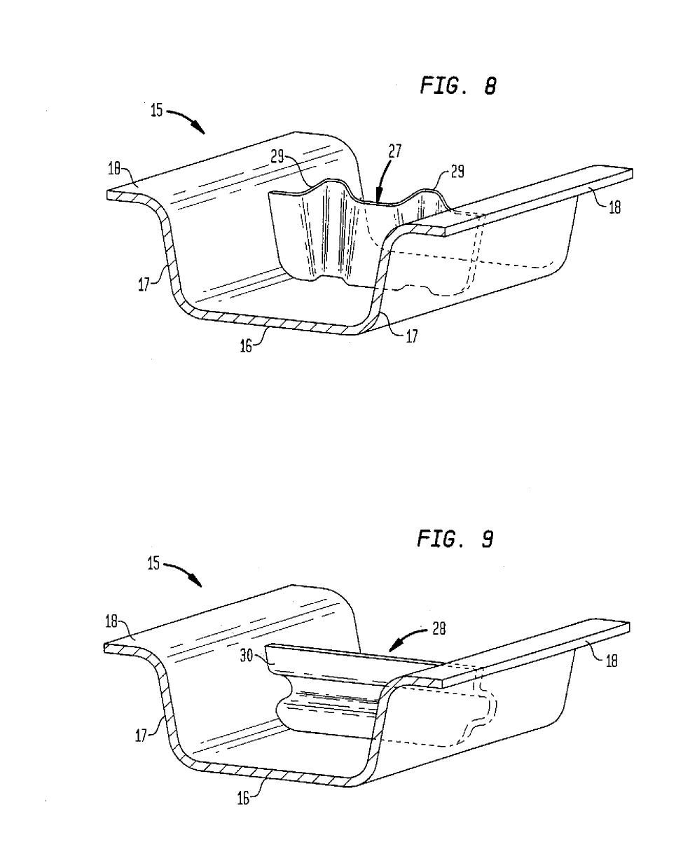

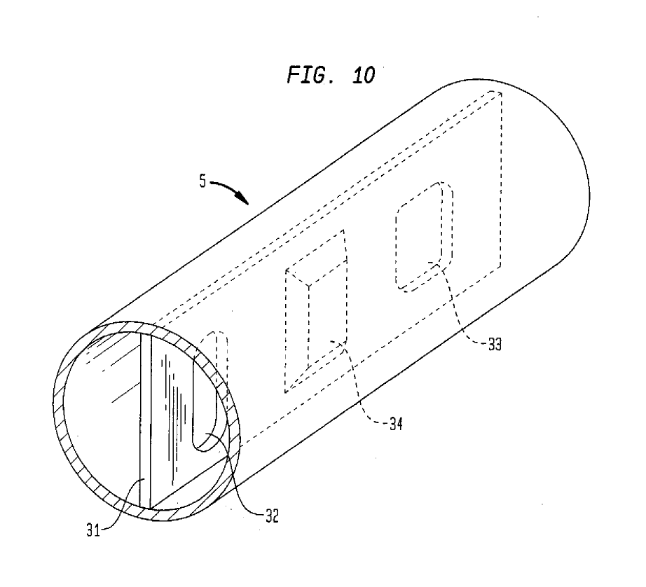

Turning now to FIG. 8, there is shown a perspective illustration of a variation of the length portion 15 of FIG. 5. Parts corresponding with those in FIG. 5 are denoted by identical reference numerals and not explained again. In this embodiment, the channel-shaped length portion 15 accommodates a transverse bulkhead 27 which is joined at least to the legs 17 but preferably also to the bottom 16. The bulkhead 27 is formed with two creases 29 directed perpendicular to the drawing plane and extending across the entire height of the bulkhead 27. FIG. 9 shows a variation of the length portion 15 with a transverse bulkhead 28 having a crease 30 which extends longitudinally between the legs 17 across the length of the bulkhead 28. Basically, the width and depth of either one of the creases 29, 30 may vary along its length.

FIG. 10 shows a cutaway view of a structural part according to the invention which corresponds essentially to the basic configuration shown in FIG. 2. The structural part has a length portion 5 in which a longitudinal bulkhead 31 is welded in. The longitudinal bulkhead 31 includes openings 32, 33 as well as an embossment 34 which juts out from the material of the longitudinal bulkhead 32 by way of a shear deformation operation.

As a consequence of the provision of creases 29, 30 as well as openings 32, 33, and embossments 34 in the transverse bulkhead 27, 28 or longitudinal bulkhead 31, the stiffness as well as the static and dynamic stress behaviors of a structural part according to the present invention can have a defined characteristic.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A structural part for a body or undercarriage of a motor vehicle, comprising:
a length portion made of steel sheet and defined by a longitudinal axis; and
a bulkhead received for reinforcement in the length portion in an area of high stress and extending in parallel relationship to the longitudinal axis.

2. The structural part of claim 1, wherein the length portion is channel-shaped.

3. The structural part of claim 1, wherein the length portion is hollow.

4. The structural part of claim 1, wherein the bulkhead is welded into the length portion.

5. The structural part of claim 1, wherein the length portion is made by shaping a plate of steel sheet.

6. The structural part of claim 5, wherein the plate is shaped to a configuration such that confronting edges of the plate are connected by welding to one another at least along a section thereof.

7. The structural part of claim 1, wherein the bulkhead is provided with a crease.

8. The structural part of claim 1, wherein the bulkhead is provided with an embossment.

9. The structural part of claim 1, wherein the bulkhead is provided with an opening.

10. The structural part of claim 2, wherein the length portion is made through a radial stamping process of a tube.

11. A method of making a structural part for a body or undercarriage of a motor vehicle, comprising the steps of:
shaping a plate of steel sheet to form a shell of U-shaped cross section;
securing a bulkhead in the shell;
bending marginal areas next to free edges of the shell about the bulkhead to form the a length portion; and
welding the edges, at least sectionwise.

12. The method of claim 11, wherein the bulkhead extends transversely to a longitudinal axis of the length portion, said bending step resulting in the formation of a tubular length portion.

13. The method of claim 11, wherein the bulkhead extends in parallel relationship to a longitudinal axis of the length portion, said bending step resulting in the formation of a box-shaped length portion.

14. The method of claim 11, wherein the welding step involves spot welding.

15. The method of claim 11, wherein the welding step involves linear welding.
